(19) United States
(12) Patent Application Publication
(10) Pub. No.: US 2015/0029232 A1
(43) Pub. Date: Jan. 29, 2015

(54) DISPLAY APPARATUS AND CONTROL METHOD THEREOF

(71) Applicant: SAMSUNG ELECTRONICS CO., LTD., Suwon-si (KR)

(72) Inventor: Jin-yong PARK, Suwon-si (KR)

(73) Assignee: SAMSUNG ELECTRONICS CO., LTD., Suwon-si (KR)

(21) Appl. No.: 14/171,281

(22) Filed: Feb. 3, 2014

(30) Foreign Application Priority Data
Jul. 26, 2013 (KR) 10-2013-0088747

(51) Int. Cl. G09G 3/28

(52) U.S. Cl. CPC G09G 3/28
USPC 345/690; 345/60

(57) ABSTRACT

A display apparatus is provided. The display apparatus includes: a self-luminous display panel; a processor configured to designate a pixel of the self-luminous display panel which corresponds to image data and configured to process the image data to be displayed as an image by discharging the self-luminous display panel so that the designated pixel emits light; and a controller configured to convert a control instruction to control an operation of an external device into a waveform according to a protocol that the external device is able to receive in response to the control instruction being received, and configured to control the external device to operate through electromagnetic interference (EMI) radiated from the self-luminous display panel by additionally discharging the self-luminous display panel with the converted waveform during a period in which the self-luminous display panel is discharged.

### CROSS-REFERENCE TO RELATED APPLICATION

This application claims priority from Korean Patent Application No. 10-2013-0088747, filed on Jul. 26, 2013 in the Korean Intellectual Property Office, the disclosure of which is incorporated herein by reference, in its entirety.

### BACKGROUND

1. Field

Apparatuses consistent with the exemplary embodiments relate to a display apparatus which processes an image signal in order to display an image, and a control method thereof. More particularly, the exemplary embodiments relate to a display apparatus having a structure configured to radiate a control signal with respect to another electronic device using a self-luminous display panel, such as a plasma display panel, and a control method thereof.

2. Description of the Related Art

A display apparatus processes an image signal input from an external image source in order to display an image on a display panel, such as a liquid crystal display (LCD) panel. The display panel may be implemented as various types of display panels, for example, an LCD panel and a plasma display panel (PDP), and may be employed for different types of display apparatuses.

Display panels used for a display apparatus may be classified into a light receiving panel and a light emitting panel, depending on the method of generating light. The light receiving panel does not emit light by itself and thus includes a separate backlight in order to generate and provide light to the panel, and an example thereof includes an LCD panel. The light emitting panel emits light by itself and thus does not need a backlight. An example thereof includes an organic light emitting diode (OLED) panel and a PDP.

Among light emitting display panels, a PDP displays an image using plasma discharge. In a PDP, a gas tube with neon or argon is injected into is disposed between two sheets of glass plates, and voltage is applied to an electrode connected to the tube to induce a plasma phenomenon. The PDP allows resulting ultraviolet rays to turn into visible light, passing through red, green and blue phosphor coatings, thereby displaying a color image.

### SUMMARY

The foregoing and/or other aspects of the exemplary embodiments may be achieved by providing a display apparatus including: a self-luminous display panel; a processor configured to designate a pixel of the self-luminous display panel which corresponds to image data and configured to process the image data to be displayed as an image by discharging the self-luminous display panel so that the designated pixel emits light; and a controller configured to convert a control instruction to control an operation of an external device into a waveform of a protocol that the external device is able to receive in response to the control instruction being received, and configured to control the external device to operate by electromagnetic interference (EMI) radiated from the self-luminous display panel, by additionally discharging the self-luminous display panel with the converted waveform during a period in which the self-luminous display panel is discharged.

One image frame displayed by the processor may include at least one sub-field. The sub-field may include an address period in which the pixel of the self-luminous display panel emitting light which corresponds to the image data is designated, and a sustain period in which light emitting from the pixel designated in the address period is maintained, and the period in which the self-luminous display panel may be discharged includes the sustain period.

The controller may perform a first discharge of the self-luminous display panel to display the image and a second discharge of the self-luminous display panel for transmission of the control instruction within the period in which the self-luminous display panel is discharged.

The controller may sequentially perform the first discharge and then perform the second discharge.

The second discharge may be performed on a transmission frequency in accordance with a protocol that the external device is able to receive, and the first discharge may be performed on a frequency which is different from the frequency for the second discharge.

The control instruction may be transmitted from an input apparatus, which is separated from the display apparatus, to the display apparatus.

The self-luminous display panel may include a plasma display panel.

The foregoing and/or other aspects may be achieved by providing a method of controlling a display apparatus including a self-luminous display panel, the control method including: receiving image data; and designating a pixel of the self-luminous display panel which corresponds to the image data and displaying an image which corresponds to the image data by discharging the self-luminous display panel so that the designated pixel emits light, wherein the displaying of the image includes receiving a control instruction to control an operation of an external device; converting the control instruction into a waveform of a protocol that the external device is able to receive, and controlling the operation of the external device by electromagnetic interference (EMI) radiated from the self-luminous display panel by additionally discharging the self-luminous display panel with the converted waveform during a period of time in which the self-luminous display panel is discharged.

One image frame displayed on the self-luminous display panel may include at least one sub-field, the sub-field may include an address period in which the pixel of the self-luminous display panel emitting light which corresponds to the image data is designated and a sustain period in which light emitting of the pixel designated in the address period is maintained, and the period of time in which the self-luminous display panel may be discharged includes the sustain period.

The additionally discharging of the self-luminous display panel may include performing a first discharge of the self-luminous display panel to display the image, and performing a second discharge of the self-luminous display panel to transmit the control instruction.

The first discharge and the second discharge may be performed sequentially.

The second discharge may be performed on a transmission frequency in accordance with a protocol that the external device is able to receive, and the first discharge may be performed on a different frequency from that of the second discharge.

The control instruction may be transmitted to the display apparatus from an input apparatus, separated from the display apparatus.

The self-luminous display panel may include a plasma display panel.

An aspect of an exemplary embodiment may provide a display apparatus including: a self-luminous display panel; a processor configured to designate a pixel of the self-luminous display panel which corresponds to image data and to process the image data by discharging the self-luminous display panel so that the designated pixel emits light; and a controller configured to convert a received control instruction into a converted waveform and control an external device by additionally discharging the self-luminous display panel with the converted waveform during a period of time in which the self-luminous display panel is discharged.

The controller may be configured to control the operation of the external device.

The controller may be configured to control the operation of the external device according to a protocol that the external device is able to receive in response to the control instruction being received.

The controller may be configured to control the external device electromagnetic interference (EMI) radiated from the self-luminous display panel.

One image frame displayed by the processor may include at least one sub-field, the sub-field may include an address period in which the pixel of the self-luminous display panel emitting light is designated and a sustain period in which light emitting from the pixel designated in the address period is maintained, and the period in which the self-luminous display panel is discharged may include the sustain period.

The controller is configured to perform a first discharge of the self-luminous display panel in order to display the image and a second discharge of the self-luminous display panel for transmission of the control instruction within the period of time in which the self-luminous display panel is discharged.

In addition, the controller may sequentially perform the first discharge and the second discharge.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram which illustrates a configuration of a display apparatus according to an exemplary embodiment.

FIG. 2 is a cross-sectional view which schematically illustrates a main part of a plasma display panel (PDP) employed in the display apparatus of FIG. 1.

FIG. 3 is a block diagram schematically which illustrates a driving structure of the PDP of FIG. 2.

FIG. 4 illustrates a method of expressing a grey level of one image frame F, using eight sub-fields in the display apparatus of FIG. 1.

FIG. 5 illustrates a concept of controlling another electronic device using the display apparatus of FIG. 1.

FIG. 6 is a flowchart which illustrates a method of controlling the display apparatus of FIG. 1.

### DETAILED DESCRIPTION OF THE EXEMPLARY EMBODIMENTS

Below, exemplary embodiments will be described in detail with reference to the accompanying drawings. The exemplary embodiments may be embodied in various forms without being limited to the exemplary embodiments set forth herein. Descriptions of well-known parts are omitted for clarity and conciseness, and like reference numerals refer to like elements throughout.

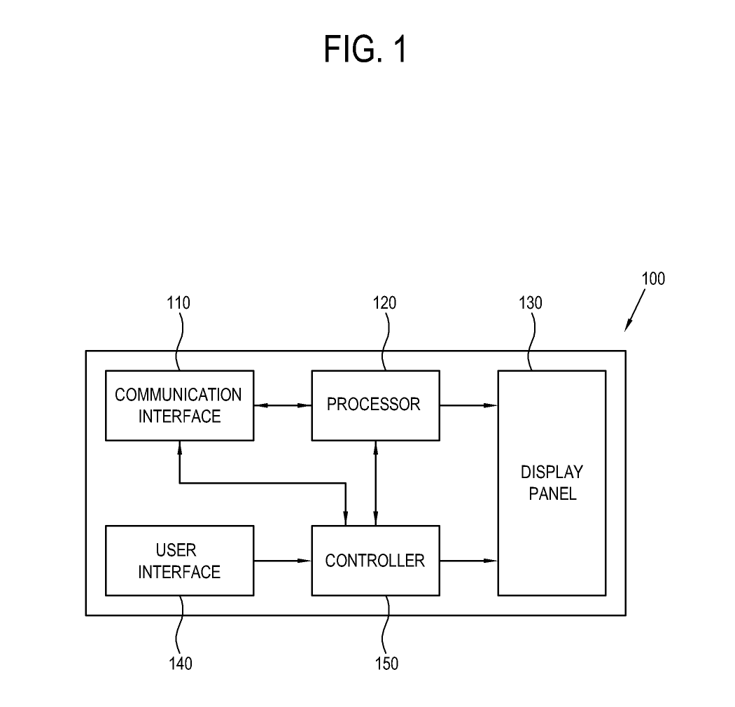

FIG. 1 is a block diagram which illustrates a configuration of a display apparatus 100, according to an exemplary embodiment.

Although the exemplary embodiments will be illustrated with a TV as the display apparatus 100, a configuration of the display apparatus 100 does not limit the disclosure of the exemplary embodiments. However, a display apparatus that tends to be stationary, such as a TV, a computer monitor and an electronic picture frame, may be used in the exemplary embodiments, instead of a mobile device, such as a portable multimedia player and a mobile phone.

As shown in FIG. 1, the display apparatus 100 according to an exemplary embodiment includes a communication interface 110 to communicate with an outside device to transmit and receive data or signals, a processor 120 to process data received by the communication interface 110 according to a preset process, a display panel 130 to display image data as an image in response to data processed by the processor 120 being image data, a user interface 140 to perform an operation input by a user, and a controller 150 to control all operations of the display apparatus 100.

The communication interface 110 transmits and receives data so that the display apparatus 100 performs two-way communications with an external device, such as a server (not shown). The communication interface 110 connects to the external device locally or via a wire-based or wireless wide area/local area network, in accordance with a preset communication protocol.

The communication interface 110 may be provided as a connection port for each device or may be provided as an assembly of connection modules, and thus a protocol for connection, or an external device as a target of connection, is not limited to one kind or form of device. The communication interface 110 may be embedded in the display apparatus 100, or the entire communication interface 110, or part of the communication interface 110 may be additionally installed in the display apparatus 100 as an add-on or alternate device.

The communication interface 110 transmits and receives signals in accordance with a protocol designed for each connected device and thus may transmit and receive a signal based on an individual communication protocol for each connected device. In the case of image data, for example, the communication interface 110 may transmit and receive a radio frequency (RF) signal and various signals in accordance with composite video, component video, super video, SCART, high definition multimedia interface (HDMI), DisplayPort, unified display interface (UDI) or wireless HD standards.

The processor 120 performs various processes on data or signals received by the communication interface 110. In response to the communication interface 110 receiving image data, the processor 120 performs an image processing process on the image data and outputs the processed image data to the display panel 130 so that an image based on the image data may be displayed on the display panel 130. In response to the communication interface 110 receiving a broadcast signal, the processor 120 extracts an image, audio and optional data from the broadcast signal tuned to a particular channel, and adjusts the image to a preset resolution in order to be displayed on the display panel 130.

The processor 120 may perform any kind of image processing process, without being limited to. For example, decoding which corresponds to an image format of image data, de-interlacing to convert interlaced image data into a progressive format, scaling to adjust image data to a preset resolution, noise reduction to improve image quality, detail enhancement, frame refresh rate conversion, or the like.

The processor 120 may perform various kinds of processes depending on the types and characteristics of data, without limiting a process performed by the processor 120 to an image processing process. Data processed by the processor 120 is not limited to data received by the communication interface 110. For example, in response to user speech being input through the user interface 140, the processor 120 may process the speech according to a preset speech processing process. In response to a motion of the user being detected through the user interface 140, the processor 120 may process a detection result according to a preset motion recognition process.

The processor 120 may be provided as an image processing board (not shown) formed by mounting an integrated multi-functional component to perform a plurality of functions, such as a system on chip (SOC), or a set of chips to independently conduct individual processes on a printed circuit board, and be embedded in the display apparatus 100.

The display panel 130 displays an image based on image signals or image data processed by the processor 120. Generally, display panels are classified into a self-luminous type having in itself a property of light emitting and a non-self-luminous type that does not emit light by itself and thus is provided with light from a backlight. In an exemplary embodiment, the display panel 130 is a self-luminous display panel, for example, a plasma display panel (PDP).

The user interface 140 transmits various preset control commands or information to the controller 160, based on a user manipulation or input. The user interface 140 forms various events, which occur by the user based on the user's intent, into information and transmits the information to the controller 160. Here, the user events may include diverse forms, for example, a manipulation, speech and gesture of the user.

The user interface 140 is configured to detect input information according to a method which corresponds to a way in which the user inputs the information. For example, the user interface 140 may be provided as a remote controller which is separate from the display apparatus 100, a menu key or input panel installed on an outside of the display apparatus 100, a touchscreen installed on the display panel 130, a microphone to input user speech, or a motion sensor or camera to detect a motion of the user.

The controller 150 is configured as a central processing unit (CPU) and controls operations of all components of the display apparatus 100, including the processor 120 in response to an event occurring. For example, in response to a command being received from the user interface 140, the controller 160 determines an operation which corresponds to the command and controls the processor 120 to perform the operation.

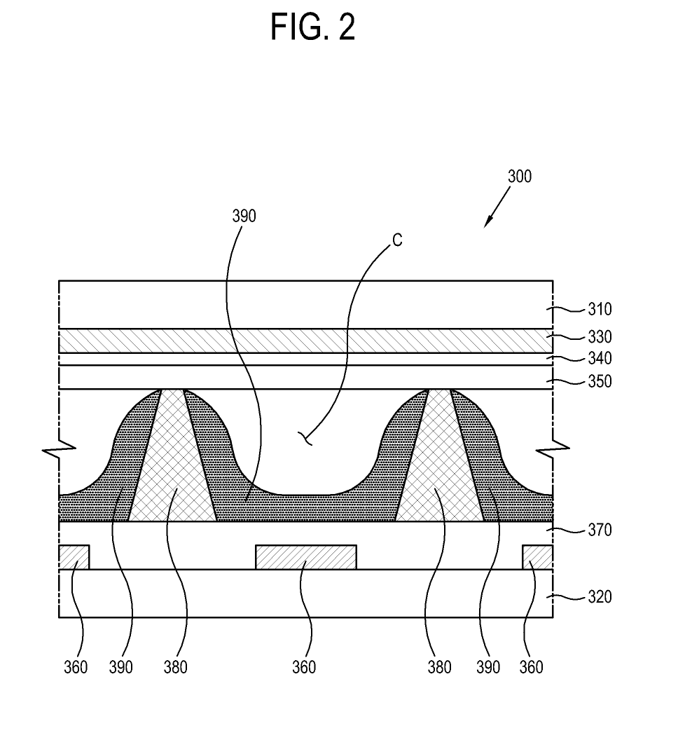

Hereinafter, a display panel 300 provided as a PDP will be described with reference to FIG. 2. The display panel 300 has a configuration substantially the same as that of the display panel 30 of FIG. 1 and may be employed in the display apparatus 100.

FIG. 2 is a cross-sectional view which schematically illustrates a main portion of the PDP 300.

The PDP 300 shown in FIG. 2 charges gas in a space between two electrodes installed in an enclosed space and applies a predetermined voltage to the electrodes to cause glow discharges, thereby forming an image by exciting a phosphor coating, by ultraviolet rays generated in the glow discharges.

The PDP 300 may be either a direct current (DC) PDP or an alternating current (AC) PDP, depending on the discharge mechanism. In a DC PDP, electrodes are exposed directly to a gas layer included in a discharge cell, and accordingly a voltage applied to the electrodes is applied straight to the discharge gas layer. In an AC PDP, electrodes are separated from a discharge gas layer by a dielectric layer, and thus charged particles generated in the electric discharge are not absorbed by the electrodes but rather form wall charges to cause discharge.

The PDP includes a front substrate 310 and a rear substrate 320 which include a transparent material, such as glass, and are disposed to face each other in order to form a discharge space.

Stripe transparent electrodes 330 are formed on the front substrate 310 at regular intervals, and stripe bus electrodes 340 having an electrode material with high ion conductivity, such as chrome (Cr) or silver (Ag), are formed on the transparent electrodes 330, with a smaller width than that of the transparent electrodes 330. The transparent electrodes 330 and the bus electrodes 340 are covered with a dielectric layer 350.

Stripe address electrodes 360 are formed on the rear substrate 320 to be perpendicular to the transparent electrodes 330 and the bus electrodes 340. The address electrodes 360 are covered with a dielectric layer 370.

A plurality of partition walls 380 is successively formed upright on the dielectric layer 370 to form a discharge cell C between the partition walls 380. A phosphor coating 390 is formed on an internal wall of the discharge cells C, extending from a lateral side of the partition walls 380 to a bottom side.

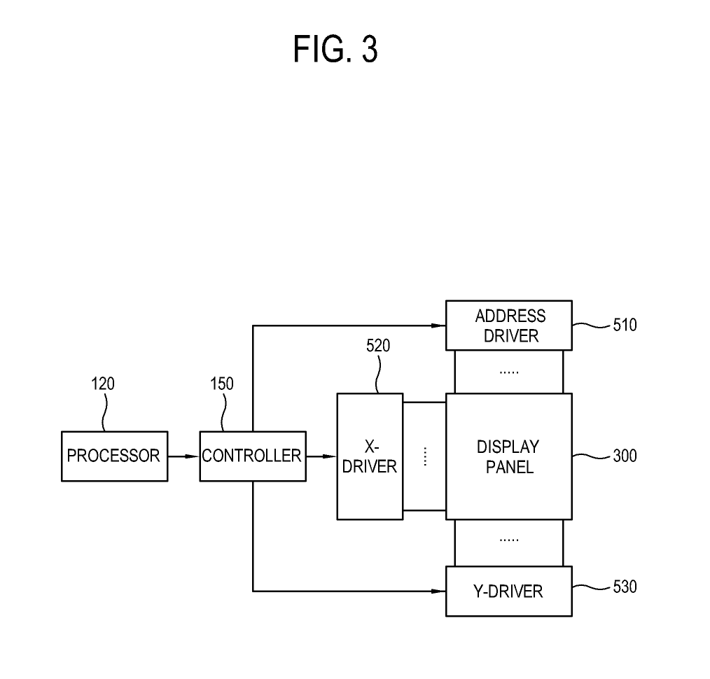

FIG. 3 is a block diagram which schematically illustrates a structure for driving display panel 300.

As shown in FIG. 3, the display panel 300 includes an address driver 510 to generate an address pulse for controlling a turn-on state of a cell to turn on the cell from among cells which correspond to an image signal output from the processor 120. That is, digital image data, and a discharge state of the cell after turn-on, an X-driver 520 and a Y-driver 530 supply sustain voltage to each cell. The address pulse includes a writing pulse and an erase pulse.

The controller 150 controls the address driver 510, the X-driver 520 and the Y-driver 530, thereby controlling address information and a state of voltage supplied to an electrode of each cell. The address information is information related to a location of the cell to turn on which corresponds to the image data among the cells.

In response to the controller 150 synchronizing with a particular frame of the image data from the processor 120 to drive the X-drive 520 and the Y-driver 530, the X-drive 520 and the Y-driver 530 supply a sustain voltage to the electrode of each cell.

Subsequently, in response to the controller 150 converting the image data into address information and provides the address information to the address driver 510, the address driver 510 outputs a writing pulse and an erase pulse at regular intervals to turn on the cell. At a time to start one frame, an erase pulse is output to all cells, according to a reset signal, and accordingly, residual charges or residual electrons which remain from a previous frame are eliminated. Further, the controller 150 adjusts a number of writing pulses when adjusting luminance.

The controller 150 may express a grey level of an image displayed on the display panel 300 by using various control methods. Among the methods, address display separation (ADS) expresses a grey level of one image frame using n sub-fields in displaying the frame.

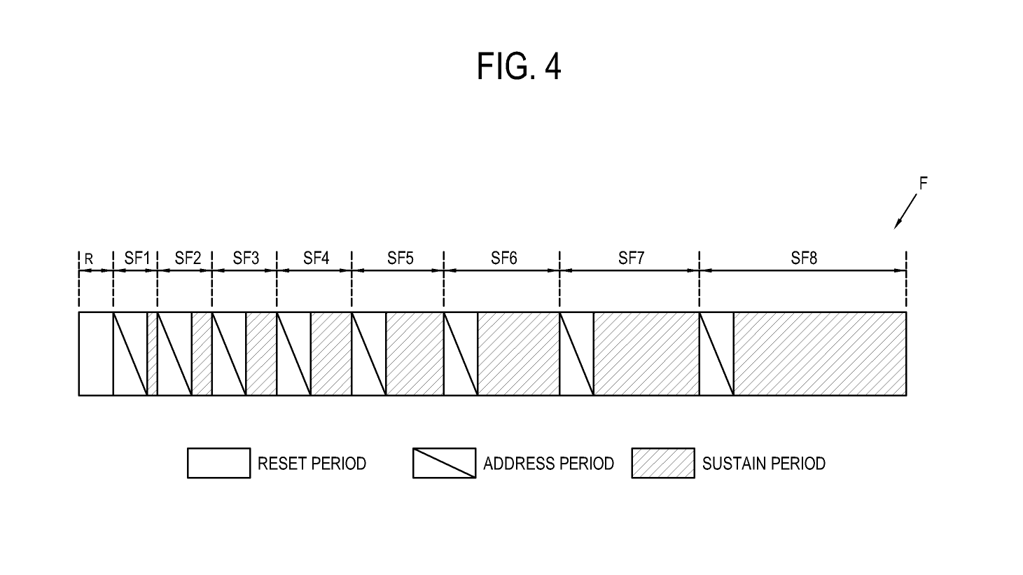

Hereinafter, a method of expressing 256 grey levels using eight sub-fields will be described as illustrated in FIG. 4.

FIG. 4 illustrates a method of expressing a grey level of one image frame F by using eight sub-fields.

As shown in FIG. 4, a time period in which one image frame F is displayed may be divided into n sections. For example, eight sub-fields SF1 to SF8 including different image information amounts or different luminance levels.

The sub-fields SF1 to SF8 each include an address period in which a pixel of the display panel 300, allowed to emit light which corresponds to image data, is designated and a sustain period in which light emitting from the designated pixel in the address period is maintained.

The sustain periods of the respective sub-fields SF1 to SF8 have different luminance levels. That is, the respective sub-fields SF1 to SF8 have different sub-field weights.

For example, the sub-fields SF1 to SF8 have 2⁽ⁿ⁻¹⁾ sub-field weights, such as 1, 2, 4, 8, 16, 32, 64 and 128, respectively. A total sum of the weights of the sub-fields SF1 to SF8 of the image frame F is 256, and accordingly the grey level of the image frame F may be expressed based on which of the sub-fields SF1 to SF8 is addressed. That is, the grey level or grey scale of the image frame F is expressed as an integrated quantity of a luminance level presented by the sub-fields SF1 to SF8 of the image frame F.

For example, in response to the grey level of the image frame F being 3, the controller 150 selects and addresses SF1 and SF3 from among the sub-fields SF1 to SF8. In response to the grey level of the image frame F being 127, the controller 150 selects and addresses SF1, SF2, SF3, SF4, SF5, SF6 and SF7 from among the sub-fields SF1 to SF8. In response to the grey level of the image frame F being 256, the controller 150 addresses all sub-fields SF1 to SF8.

However, in response to the image frame F being displayed on the display panel 300 in this method, residual electrons which do not contribute to discharge for image display may remain on the display panel 300. The residual electrons cause deterioration in image quality or image distortion in response to a next image frame F being displayed on the display panel 300.

Thus, the controller 150 periodically applies high voltage to the entire display panel 300 to generate light for a short period of time, thereby conducting a discharge for eliminating the residual electrons. Such a process is referred to as a reset operation, and a time period in which the reset operation is performed is defined as a reset period.

A cycle of the reset period may be determined in various ways. Referring to FIG. 4, the reset period may be performed prior to the sub-fields SF1 to SF8 of the image frame F whenever the image frame F is displayed. Alternatively, the reset period may be performed on each cycle of a predetermined number of frames F or on each cycle of the respective sub-fields SF1 to SF8.

In a service environment, the display apparatus 100 may be installed alone or along with various electronic devices (not shown). In the related art, each electronic device includes an individual remote controller (not shown) and receives an infrared signal transmitted from the remote controller in order to operate. For user convenience, a single remote controller may be provided to control all electronic devices, instead of separate remote controllers for each of the respective electronic devices. Further, a remote controller to control all electronic devices may be the user interface 140 of the display apparatus 100 or the remote controller may be a general-purpose remote controller.

However, since infrared light is not easy to radiate or project far away, a relay device may be needed to radiate a control signal from the remote controller to a plurality of electronic devices, via infrared light. Although the relay device may be configured to include a plurality of infrared irradiation units to project infrared light in all directions, the related device is separately installed in the service environment and thus accompanying considerations of costs and installation space may arise.

Thus, an exemplary embodiment suggests the following method.

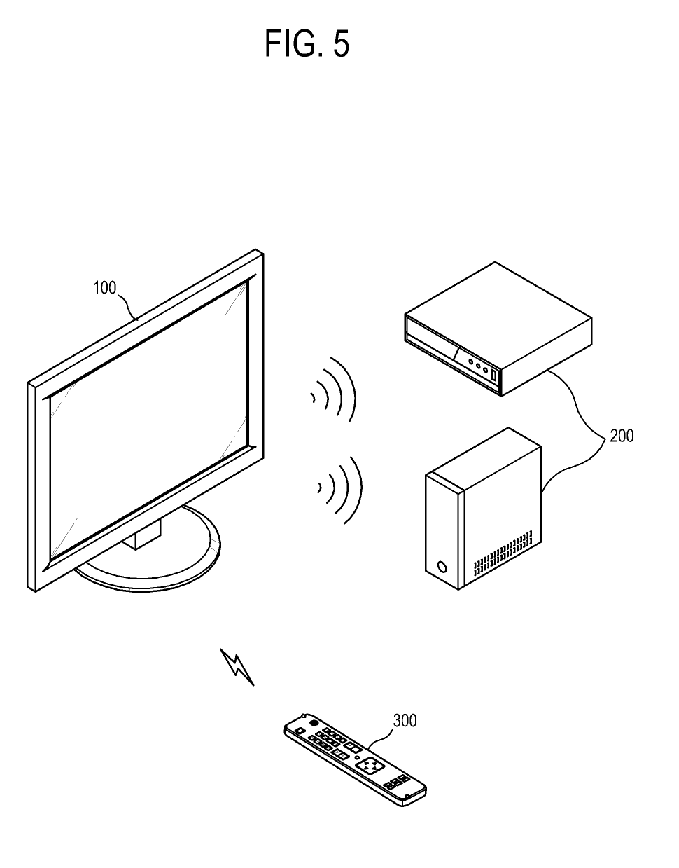

FIG. 5 illustrates a concept of controlling another electronic device 200, via the display apparatus 100.

As shown in FIG. 5, a system according to an exemplary embodiment includes the display apparatus 100 and at least one more electronic devices 200. A user may control the display apparatus 100 and the electronic devices 200 using a remote controller 300.

The remote controller 300 may be the user interface 140 of the display apparatus 100 or the remote controller may be a separate general-purpose remote controller. The remote controller 300 is configured to designate one of the display apparatus 100 and the electronic devices 200 and to provide an instruction to operate the designated device.

According to an exemplary embodiment, in response to a control instruction to control an operation of the electronic device 200 being received from the remote controller 300, the display apparatus 100 converts the control instruction into a waveform in accordance with a protocol that the electronic device 200 is able to receive. The display apparatus 100 additionally discharges the display panel 130 with the converted waveform during a period of time in which the display panel 130 is discharged.

In response to the display panel 130 being discharged, electromagnetic interference (EMI) is radiated from the display panel 130, and the electronic device 200 may receive the EMI within a preset distance from the display panel 130.

During a discharge period of the display panel 130, that is, the sustain periods of the sub-fields SF1 to SF8 shown in FIG. 4, the display apparatus 100 sequentially performs a first discharge of the display panel 130 for image display and second discharge of the display panel 130 for transmission of the control instruction.

The second discharge is performed on a frequency that the electronic device 200 may receive, for example, 40 kHz in a case of an infrared transmission protocol. The first discharge is performed on a different frequency from that for the second discharge to prevent malfunction of the electronic device 200, for example, 100 kHz. Since the first discharge and the second discharge are performed during the given sustain periods, the first discharge may be performed at a higher frequency than the second discharge.

That is, the display apparatus 100 additionally discharges the display panel 130 with a waveform of a control instruction to the electronic device 200 at a frequency of a preset protocol, during a preset sustain period.

Accordingly, the electronic device 200 does not react to EMI by the first discharge but may receive EMI through the second discharge. In response to the EMI radiated from the display apparatus 100 including a control instruction, the electronic device 200 operates according to the control instruction. Thus, the display apparatus 100 may serve to relay an infrared signal without a separate relay device to relay an infrared signal.

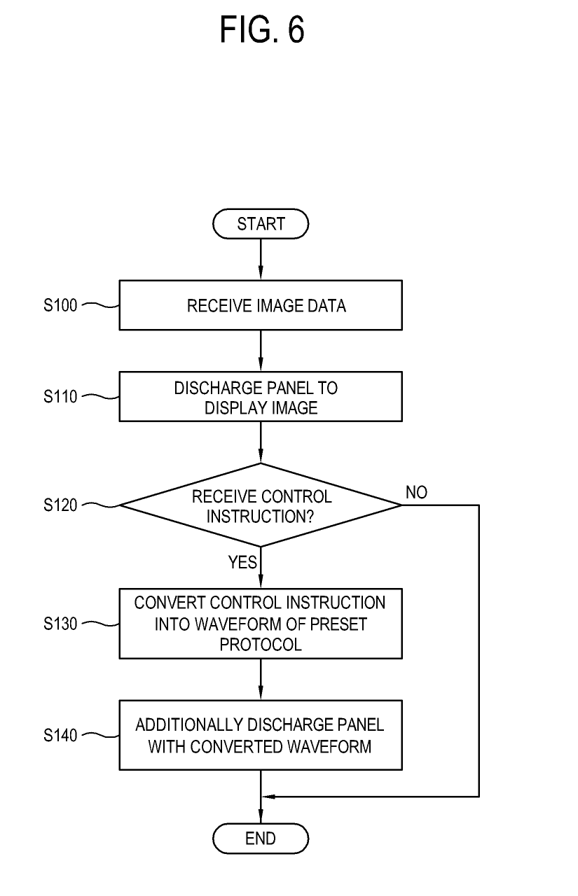

Hereinafter, a method of controlling the display apparatus 100 will be described in detail with reference to FIG. 6.

FIG. 6 is a flowchart which illustrates the control method of the display apparatus 100.

As shown in FIG. 6, the display apparatus 100 receives image data in operation 5100. The display apparatus 100 discharges the display panel 130 to display an image which corresponds to the received image data, in operation 5110.

In response to a control instruction to control an operation of the electronic device 200 being received by the display apparatus 100 in operation 5120, the display apparatus 100 converts the control instruction into a waveform of a preset protocol so that the electronic device 200 receives the control instruction in operation 5130. The display apparatus 100 additionally discharges the display panel 130 with the converted waveform during a period of time in which the display panel 130 is discharged in order to display the image, in operation 5140.

Accordingly, the electronic device 200 may receive EMI radiated from the display panel 130 in an additional discharge and operate according to the control instruction included in the received EMI.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a self-luminous display panel;
a processor configured to designate a pixel of the self-luminous display panel which corresponds to image data and configured to process the image data to be displayed as an image by discharging the self-luminous display panel so that the designated pixel emits light; and
a controller configured to convert a control instruction to control an operation of an external device into a waveform according to a protocol that the external device is able to receive in response to the control instruction being received, and configured to control the external device to operate by electromagnetic interference (EMI) radiated from the self-luminous display panel by additionally discharging the self-luminous display panel with the converted waveform during a period of time in which the self-luminous display panel is discharged.

2. The display panel of claim 1, wherein one image frame displayed by the processor comprises at least one sub-field, the sub-field comprises an address period in which the pixel of the self-luminous display panel emitting light which corresponds to the image data is designated and a sustain period in which light emitting from the pixel designated in the address period is maintained, and the period in which the self-luminous display panel is discharged comprises the sustain period.

3. The display apparatus of claim 1, wherein the controller performs a first discharge of the self-luminous display panel to display the image and a second discharge of the self-luminous display panel for transmission of the control instruction within the period of time in which the self-luminous display panel is discharged.

4. The display apparatus of claim 3, wherein the controller sequentially performs the first discharge and the second discharge.

5. The display apparatus of claim 3, wherein the second discharge is performed on a transmission frequency in accordance with a protocol that the external device is able to receive, and the first discharge is performed on a different frequency from that of the second discharge.

6. The display apparatus of claim 1, wherein the control instruction is transmitted to the display apparatus from an input apparatus which is separated from the display apparatus.

7. The display apparatus of claim 1, wherein the self-luminous display panel comprises a plasma display panel.

8. A method of controlling a display apparatus comprising a self-luminous display panel, the control method comprising:
receiving image data; and
designating a pixel of the self-luminous display panel which corresponds to the image data and displaying an image which corresponds to the image data by discharging the self-luminous display panel so that the designated cell emits light,
wherein the displaying of the image comprises receiving a control instruction to control an operation of an external device; and converting the control instruction into a waveform according to a protocol that the external device is able to receive and controlling the external device to operate by electromagnetic interference (EMI) radiated from the self-luminous display panel by additionally discharging the self-luminous display panel with the converted waveform during a period in which the self-luminous display panel is discharged.

9. The control method of claim 8, wherein one image frame displayed on the self-luminous display panel comprises at least one sub-field, the sub-field comprises an address period in which the pixel of the self-luminous display panel emitting light which corresponds to the image data is designated and a sustain period in which light emitting from the pixel designated in the address period is maintained, and the period in which the self-luminous display panel is discharged comprises the sustain period.

10. The control method of claim 8, wherein additionally discharging the self-luminous display panel comprises performing a first discharge of the self-luminous display panel for displaying the image, and performing a second discharge of the self-luminous display panel for transmission of the control instruction.

11. The control method of claim 10, wherein the first discharge and the second discharge are performed sequentially.

12. The control method of claim 10, wherein the second discharge is performed on a transmission frequency in accordance with a protocol that the external device is able to receive, and the first discharge is performed on a different frequency from that of the second discharge.

13. The control method of claim 8, wherein the control instruction is transmitted to the display apparatus from an input apparatus which is separated from the display apparatus.

14. The control method of claim 8, wherein the self-luminous display panel comprises a plasma display panel.

15. A display apparatus comprising:
a self-luminous display panel;
a processor configured to designate a pixel of the self-luminous display panel which corresponds to image data and to process the image data by discharging the self-luminous display panel so that the designated pixel emits light; and
a controller configured to convert a received control instruction into a converted waveform and control an external device by additionally discharging the self-luminous display panel with the converted waveform during a period of time in which the self-luminous display panel is discharged.

16. The display apparatus of claim 15, wherein the controller is configured to control the operation of the external device.

17. the display apparatus of claim 16, wherein the controller is configured to control the operation of the external device according to a protocol that the external device is able to receive in response to the control instruction being received.

18. The display apparatus of claim 17, wherein the controller is configured to control the external device electromagnetic interference (EMI) radiated from the self-luminous display panel.

19. The display panel of claim 18, wherein one image frame displayed by the processor comprises at least one sub-field, the sub-field comprises an address period in which the pixel of the self-luminous display panel emitting light is designated and a sustain period in which light emitting from the pixel designated in the address period is maintained, and the period in which the self-luminous display panel is discharged comprises the sustain period.

20. The display apparatus of claim 19, wherein the controller performs a first discharge of the self-luminous display panel in order to display the image and a second discharge of the self-luminous display panel for transmission of the control instruction within the period of time in which the self-luminous display panel is discharged.

21. The display apparatus of claim 20, wherein the controller sequentially performs the first discharge and the second discharge.
